(19) United States
(12) Patent Application Publication
(10) Pub. No.: US 2013/0153727 A1
(43) Pub. Date: Jun. 20, 2013

(54) INFINITE AXIAL ADJUSTMENT MOUNT

(71) Applicants: Brian Keith ELLIS, Union, SC (US); Roger Blaine TRIVETTE, Boiling Springs, SC (US)

(72) Inventors: Brian Keith ELLIS, Union, SC (US); Roger Blaine TRIVETTE, Boiling Springs, SC (US)

(21) Appl. No.: 13/329,955

(22) Filed: Dec. 19, 2011

(51) Int. Cl. F16M 13/00

(52) U.S. Cl. 248/289.11

(57) ABSTRACT

A novel infinite axial adjustment mount is provided for mounting an object, such as a tool, to a surface, so that the angle, direction and orientation of the object may be adjusted and secured into a desired position.

### BACKGROUND OF THE INVENTION

The present invention relates generally to mounting devices that are used to position a tool or other apparatus in a specific location and angular orientation with respect to a workpiece. More specifically, the present invention includes an infinite axial adjustment mount, which is used to mount a device or apparatus to a first surface, and which allows the angle of the attached device or apparatus to be adjusted and secured in a desired manner and orientation.

Heretofore, many different types of adjustable mounting mechanisms have been used and made commercially available for angular adjustment of a variety of different devices, such as rear-view mirror on vehicles, lamps and lighting devices, and tools. Most such adjustable mounting mechanisms employ a ball and socket type of arrangement, whereby the socket is mounted to a fixed surface, and the ball portion of the mechanism is attached to the device that requires angular adjustment. Typically, these adjustable mounts are adjusted to their desired position, and then are secured in that position by tightening a screw (or other means) to reduce the size of the socket, so that the ball is held in place tightly within the socket through frictional engagement. Unfortunately, these types of ball and socket mounts suffer from the fact that if enough force is inadvertently applied to the adjustable portion (the ball), the frictional engagement is not strong enough to prevent movement of the socket within the ball, and the adjustable portion of the mount ends up in an undesirable or unintended position.

Other types of adjustable mounts are limited by the degrees of motion in which adjustments may be made. Many mounts allow a single rotating adjustment, like an elbow, wherein the angle may be adjusted by rotating a movable arm about a pivot pin that is affixed to a fixed arm. Multiple elbow joints may be used to increase the degrees of motion for the mounting bracket, but this arrangement requires more space and a more complicated structure than ball and socket style mounts.

Still other adjustable mounts include flexible goose-neck style mechanisms, wherein the goose neck is attached to a base member at one end, and a light or other device is attached to the other, so that the goose neck mechanism may be bent in any direction to a desired position. The goose neck style adjustable mounts are designed to support the weight of the attached device, but are not designed to remain in a desired position while carrying a significant weight load.

Therefore, it would be desirable to provide a mounting device that may be attached to a first surface, and that may be adjusted angularly in a desired position and locked into place. Additionally, it would be desirable to provide a mechanism for securing the desired angle of the mount in a more secure manner, and wherein the mechanism for securing the desired angle is easy to loosen for additional adjustment purposes. Finally, it would be desirable to provide an infinitely axially adjustable mount that may be secured into any desired position while bearing a significant weight load.

### BRIEF SUMMARY OF THE INVENTION

In accordance with one aspect of the invention, an infinite axial adjustment mount is provided. The mount includes a fixed mounting plate that may be attached to any surface, and an adjustable mounting plate that may be angularly adjusted with respect to the fixed mounting plate, and secured in a desired position. The fixed mounting plate includes a generally centrally disposed, hemispherically shaped bulb that is adapted to fit into a correspondingly shaped socket positioned on the adjustable mounting plate. This bulb/socket mechanism allows the adjustable mounting plate to be moved and adjusted, so that the adjustable mounting plate is disposed at a desired angle with respect to the fixed mounting plate. The hemispherically shaped bulb of the fixed mounting plate and the correspondingly shaped socket of the adjustable mounting plate also include a centrally located hole, through which a securing screw may be placed and tightened in order to secure the adjustable mounting plate to the fixed mounting plate in a desired position. Additionally, the adjustable mounting plate includes additional adjustable supports, such as a series fine adjustment screws that are threaded through threaded holes disposed about an outer portion of the adjustable mounting plate. These fine adjustment screws serve essentially as spacers between the fixed mounting plate and the adjustable mounting plate, in order to maintain the proper desired angle of the adjustable mounting plate with respect to the fixed mounting plate.

### BRIEF DESCRIPTION OF THE DRAWINGS

These and other features, aspects, and advantages of the present invention will become better understood with regard to the following description, appended claims, and accompanying drawings where:

FIG. 1 is an exploded perspective view of one embodiment of an infinite axial adjustment mount;

FIG. 2 is a side cross-sectional view of one embodiment of an infinite axial adjustment mount;

FIG. 3 is a top view of one embodiment of an infinite axial adjustment mount; and

FIG. 4 is a side cross-sectional view of one embodiment of an infinite axial adjustment mount, wherein the adjustable mount plate is secured at an angle with respect to the fixed mount plate.

### DETAILED DESCRIPTION OF THE INVENTION

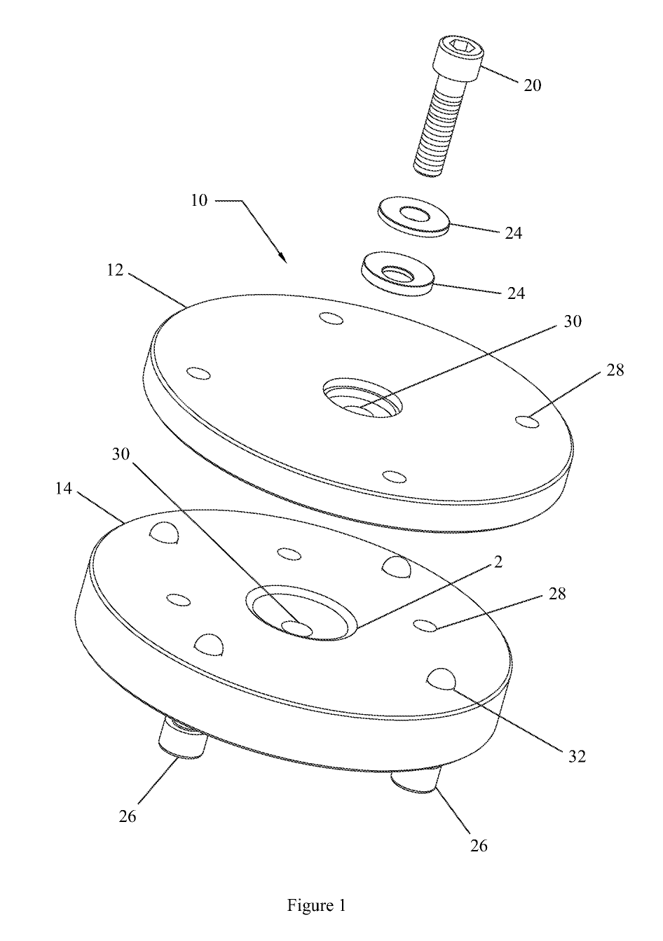

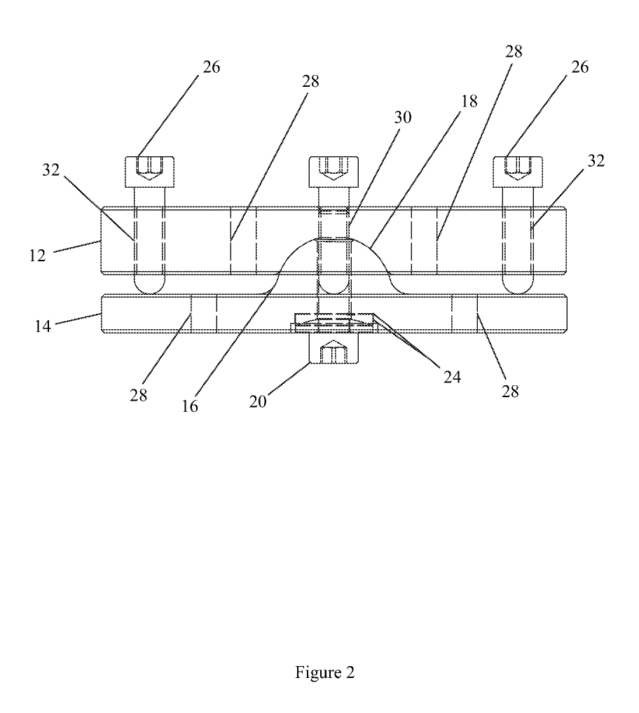

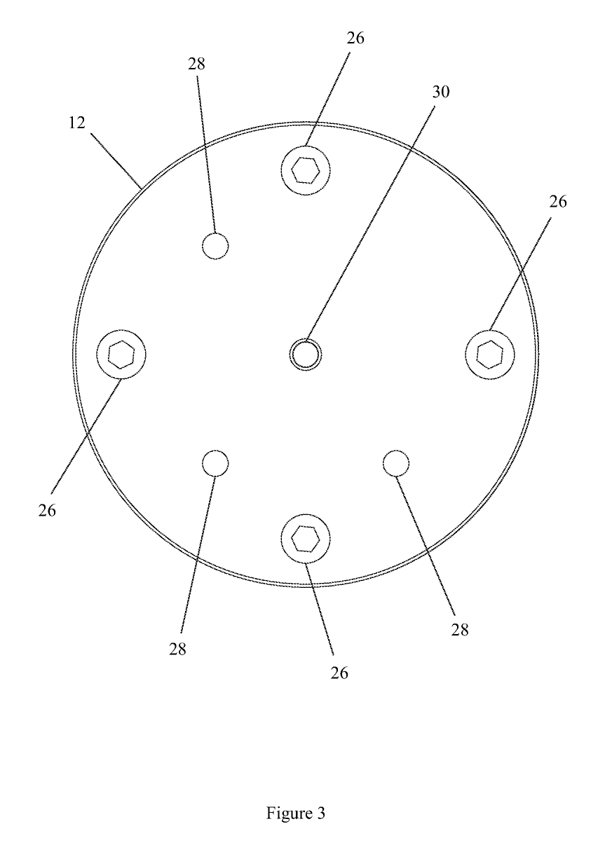

The present invention includes, in a first embodiment, an infinite axial adjustment mount 10 that is used to mount an object, such as a tool, to a surface, so that the angle, direction and orientation of the object may be adjusted and secured into a desired position. As shown in FIGS. 1-4, the infinite axial adjustment mount 10 includes a fixed mounting plate 12 and an adjustable mounting plate 14 that may be secured to the fixed mounting plate 12 in any desired position. The fixed mounting plate 12 includes a generally centrally located hemispherically shaped protruding bulb 16. This bulb 16 is adapted to fit into a correspondingly shaped socket 18 or indentation that is generally centrally located on the adjustable mounting plate 14. The bulb 16 and socket 18 each include a generally centrally located hole 30, so that a securing screw 20 may extend through both holes 30, and may be tightened down in order to secure the adjustable mounting plate 14 to the fixed mounting plate 12 in a desired angle and orientation. The adjustable mounting plate 14 may be adjusted angularly in any desired position, and may spin about the securing screw 20 when the securing screw 20 is in a loosened position. In a preferred embodiment, the securing screw 20 may also include a single or multiple spherical washers 24 disposed thereabout, as shown.

Both the fixed mounting plate 12 and the adjustable mounting plate 14 may include a bolt pattern 28, or series of holes, which allows each plate 12, 14 to be secured to an external device or surface. For instance, it is contemplated that the fixed mounting plate 12 may be secured to a surface using bolts that extend through the bolt pattern holes 28, and the adjustable mounting plate 14 may be attached to a tool, such as a drill, or the like, similarly using the bolt pattern holes 28. Although the mounting plates 12, 14 are described as having a bolt pattern 28 for attachment to other devices or surfaces, it should be understood that any other suitable attachment means may be used for such purposes.

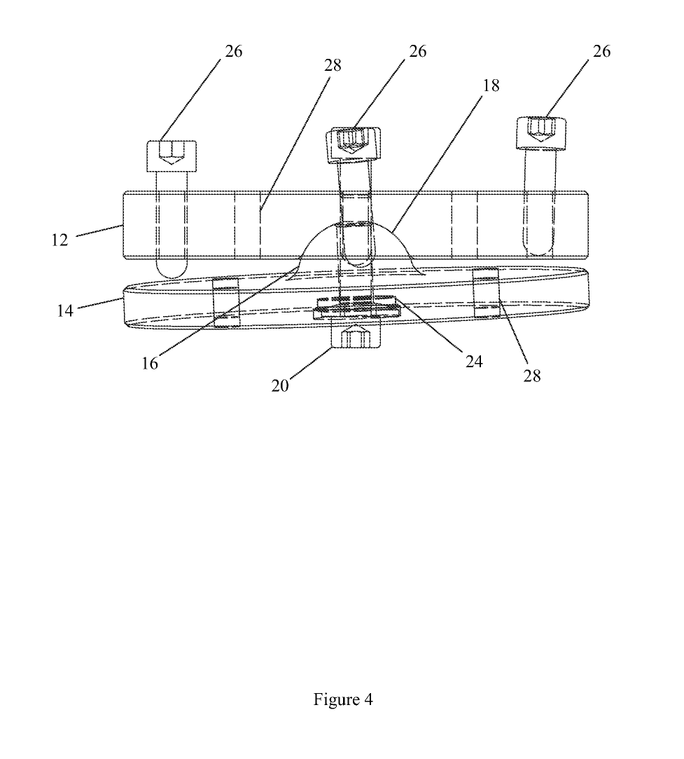

The adjustable mounting plate may also include a series of fine adjustment screw holes 32 about an outer periphery thereof in order to receive fine adjustment screws 26, as shown. The fine adjustment screws 26 extend from an outer side of the adjustable mounting plate 14, through the holes 32, and ultimately come into contact with the underside of the fixed mounting plate 12 which faces the adjustable mounting plate 14. The fine adjustment screws 26 essentially serve as spacers, which may be adjusted to dispose the adjustable mounting plate 14 in a desired angular orientation with respect to the fixed mounting plate 12, as shown in FIG. 4.

In use, the fixed mounting plate 12 is mounted to a desired surface, and a tool or desired object is attached to adjustable mounting plate 14. The securing screw 20 is loosened to allow the adjustable mounting plate 14 to move freely about the securing screw 20, both angularly, and so that the adjustable mounting plate 14 may spin in order to place the tool or object in the desired direction and angle. The fine adjustment screws 26 are then adjusted so that the adjustable mounting plate 14 is placed in the desired position. Then, the securing screw 20 is tightened, in order to secure the adjustable mounting plate 14 into the desired position.

The securing screw 20 and the fine adjustment screws 26 may be manually operated, or may be mechanically or electronically driven by servo-motors, for example. Additionally, other adjustment mechanisms may be used in place of the securing screw 20 and/or fine adjustment screws 26, such as hydraulic or pneumatic mechanisms. It should also be understood that the various components of the infinite axial adjustment mount 10 may be made or manufactured from any desired material, including metals, plastics, or the like. Although the fine adjustment screws 26 are described as extending through the adjustable mounting plate 14 and coming into contact with the fixed mounting plate 12, it is contemplated that the fine adjustment screws 26 may be oriented in the reverse direction, so that they extend through the fixed mounting plate 12 and come into contact with the underside of the adjustable mounting plate 14. Likewise, although the protruding bulb 16 has been described as being located on the fixed mounting plate 12 and the corresponding socket 18 or indentation has been described as being located on the adjustable mounting plate 14, the converse arrangement may also be used, wherein the protruding bulb 16 may be located on the adjustable mounting plate 14, while the corresponding socket 18 or indentation may be positioned on the fixed mounting plate 12.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. An adjustable mount comprising:
a fixed mounting plate including a protruding, generally hemispherically shaped bulb in a central portion thereof;
an adjustable mounting plate including a generally hemispherically shaped socket in a central portion thereof, wherein said socket is adapted to receive said bulb of said fixed mounting plate;
means for mounting said fixed mounting plate to a surface;
means for securing said adjustable mounting plate to said fixed mounting plate
means for attaching an object to said adjustable mounting plate; and
at least one fine adjustment screw extending between said fixed mounting plate and said adjustable mounting plate for adjusting an angle between said fixed mounting plate and said adjustable mounting plate.

2. The adjustable mount set forth in claim 1, wherein said bulb and socket each define a hole, and wherein said means for securing said adjustable mounting plate to said fixed mounting plate include a securing screw that extends through said hole in said bulb and said hole in said socket.

3. The adjustable mount set forth in claim 1, further including a plurality of said fine adjustment screws extending between said fixed mounting plate and said adjustable mounting plate for adjusting an angle between said fixed mounting plate and said adjustable mounting plate.

4. The adjustable mount set forth in claim 3, wherein said fine adjustment screws extend through said adjustable mounting plate and come into contact with said fixed mounting plate.

5. The adjustable mount set forth in claim 3, wherein said fine adjustment screws extend through said fixed mounting plate and come into contact with said adjustable mounting plate.

6. An adjustable mount comprising:
an adjustable mounting plate including a protruding, generally hemispherically shaped bulb in a central portion thereof;
a fixed mounting plate including a generally hemispherically shaped socket in a central portion thereof, wherein said socket is adapted to receive said bulb of said fixed mounting plate;
means for mounting said fixed mounting plate to a surface;
means for securing said adjustable mounting plate to said fixed mounting plate
means for attaching an object to said adjustable mounting plate; and
at least one fine adjustment screw extending between said fixed mounting plate and said adjustable mounting plate for adjusting an angle between said fixed mounting plate and said adjustable mounting plate.

7. The adjustable mount set forth in claim 6, wherein said bulb and socket each define a hole, and wherein said means for securing said adjustable mounting plate to said fixed mounting plate include a securing screw that extends through said hole in said bulb and said hole in said socket.

8. The adjustable mount set forth in claim 6, further including a plurality of said fine adjustment screws extending between said fixed mounting plate and said adjustable mounting plate for adjusting an angle between said fixed mounting plate and said adjustable mounting plate.

9. The adjustable mount set forth in claim 8, wherein said fine adjustment screws extend through said adjustable mounting plate and come into contact with said fixed mounting plate.

10. The adjustable mount set forth in claim 8, wherein said fine adjustment screws extend through said fixed mounting plate and come into contact with said adjustable mounting plate.
